(19) United States
(12) Patent Application Publication
(10) Pub. No.: US 2012/0199315 A1
(43) Pub. Date: Aug. 9, 2012

(54) ANTI-CONDENSATION METHOD AND DEVICE FOR AN AIRCRAFT

(75) Inventors: Laurent BARREAU, L'UNION (FR); Michel EGLEM, TOULOUSE (FR); Philippe HERAUD, TOULOUSE (FR)

(73) Assignee: LIEBHERR-AEROSPACE TOULOUSE SAS, TOULOUSE (FR)

(21) Appl. No.: 13/369,441

(22) Filed: Feb. 9, 2012

(30) Foreign Application Priority Data
Feb. 9, 2011 (FR) 11.00398

(51) Int. Cl. B60H 3/00; F24H 1/10

(52) U.S. Cl. 165/42; 392/465

(57) ABSTRACT

Described is an anti-condensation method for an aircraft (13), wherein part of a stream of cold air is withdrawn, the part of a stream of cold air is heated, and the part of the stream of hot air is introduced into the crown (19) of the aircraft (13) through an air introduction duct (8). Also described is an anti-condensation device called “Air Dryer System”.

The invention relates to an anti-condensation method and device for an aircraft. The invention relates to such an anti-condensation method and device which are adapted in particular to limit in a preventive manner—especially substantially to prevent—the formation of liquid water by condensation of water vapor on an inner face—in particular on a cold inner face—of the fuselage of an aircraft. The invention relates also to such an anti-condensation method and device which are adapted to eliminate the liquid water which is formed in contact with a cold wall of an aircraft and is liable to accumulate in that region.

It is known that the fuselage of an aircraft flying at high altitude—especially the outer surface of said fuselage—is exposed to temperatures of approximately from −40° C. to −56° C., while the temperature of the air inside the passenger cabin is maintained at an optimum value of approximately +20° C. Furthermore, it is also known that, for the passengers' comfort, the air inside the cabin must have a moisture content of greater than 10%—especially of at least approximately from 20 to 30%. As a result, the moisture in the cabin air tends to generate liquid water by condensation of the moisture in the cabin air when it comes into contact with the cold inside face of the fuselage of the aircraft. This liquid water generated by condensation which gradually accumulates in the aircraft constitutes a variable extra load for the aircraft, to the detriment of its pay load and its fuel consumption. Furthermore, the accumulation of liquid water inside the aircraft is liable to damage the on-board equipment of the aircraft, in particular by disrupting the operation of the electrical equipment of the aircraft and by embrittling the structural elements of the aircraft which are likely to be damaged by corrosion.

There are already known various devices and methods for treating the cabin air of an aircraft, allowing hot air to be circulated inside the space between the outside walls of the cabin and the inside face of the fuselage of an aircraft.

In particular, there is known from WO 00/37313 a device for distributing air in the cabin of an aircraft, in which hot air is taken from the region of the engines of the aircraft and mixed with air produced by an air conditioning device. Such a device comprises an element for monitoring and adjusting the humidity of the air introduced into the passenger cabin and into the space between the inside face of the fuselage and an insulating wall extending opposite said inside face of the fuselage.

Such a solution requires dry and hot air to be taken from the region of the compressors of the engines of the airplane. As a result, there is a loss of power of the engines. Furthermore, such a solution does not make it possible to reduce the formation of liquid water by condensation of the water vapor in the moist air in contact with the cold inner face of the fuselage of the aircraft.

There is also known (U.S. Pat. No. 5,386,952) a device for dehumidifying cabin air, which device is positioned in the upper part of the aircraft and is adapted to convert moist and cold air into substantially dry hot air. Such a dehumidifying device comprises a material—especially a silica gel—for trapping the moisture of the air that passes through said material, and an electric heating element for purging air.

Such a device is heavy, weighing approximately 18.5 kg, and constitutes an extra load for the aircraft. Furthermore, such a device requires annual replacement of the silica gel and increases the maintenance operations of the aircraft. Such a device is expensive, and its operation requires a high electric energy consumption of approximately 4.5 kW.

The invention aims to remedy the disadvantages mentioned above by proposing an anti-condensation method and device adapted to limit—or even prevent—the formation, by condensation of the moisture in the air, of liquid water in contact with the inner face of the inner wall of the fuselage of an aircraft, in particular in contact with the inner face of the inner wall of the fuselage which extends opposite the upper wall of the passenger cabin—in particular, but not exclusively, under flying conditions.

The invention relates generally to such an anti-condensation method and device which are adapted to reduce—or even completely prevent—the deposit of liquid water by condensation of the moisture in the air circulating in the space between a cabin wall and a fuselage wall of an aircraft, in particular in the crown of an aircraft.

The invention relates also to such an anti-condensation method and device for eliminating the liquid water formed by condensation of water vapor on the cold walls of the fuselage of the aircraft—especially during a phase of re-starting of the aircraft after a lengthy stop.

The invention aims also to propose such an anti-condensation method and device which do not require additional hot air to be withdrawn from the region of the engines, the operation of which is not disrupted and the power of which remains wholly available for driving the aircraft.

The invention relates also to such an anti-condensation method and device which do not require the use of specific additional equipment for dehumidification by capture of the moisture of the cabin air.

In particular, the invention aims also to propose such an anti-condensation method and device which do not require the use of a device for trapping the moisture in the air in a gel and which has to be replaced during maintenance operations on the aircraft.

The invention aims also to propose such an anti-condensation method and device which are compatible with the constraints regarding the safety, comfort and well-being of the passengers of an aircraft.

The invention aims also to propose such an anti-condensation method and device which are compatible with the constraints of aircraft fuel consumption and which do not lead to a significant increase in the pay load of the aircraft.

In particular, the invention relates also to such an anti-condensation method and device which are of low energy consumption and are adapted to the constraints of energy autonomy of an aircraft.

The invention aims also to propose such a device which does not require radical structural modification of the on-board equipment of said aircraft. In particular, the invention relates to such a device which does not require the installation of a pipe system for the distribution of air throughout the peripheral space bounded by the fuselage of the aircraft.

The invention relates also to an anti-condensation device which is capable of being installed and operated in any type of aircraft, on construction of said aircraft or during maintenance operations on said aircraft and/or during a modification, carried out at a specialist centre, of the aircraft which has already been taken into service.

The invention aims also to achieve all these objects at low cost, by proposing an anti-condensation method and device of low cost price.

To this end, the invention relates to an anti-condensation method for an aircraft, said aircraft comprising:
a cabin adapted to be able to receive passengers;
a fuselage;
a space, called the crown, which extends between an upper wall of the cabin and a wall of the fuselage;
an air conditioning device adapted to supply the cabin with air adapted to maintain the safety and comfort of the passengers;
the air conditioning device comprising at least one device for cooling air at a temperature of from +10° C. to +60° C., said cooling device comprising at least one air inlet and at least one outlet for a stream of air, called cold air, having a temperature of from −1° C. to +5° C.;
   wherein:
   at least part of the stream of cold air is withdrawn; and then
   a step is carried out in which said part of the stream of cold air is heated so as to form a stream of air, called hot air, at a temperature of from +10° to +60° C.—especially of approximately +35° C.; and then
   the stream of hot air obtained is introduced into the crown of the aircraft.

Throughout the text, the terms of orientation “upper, lower” are to be understood with reference to the position and orientation of the aircraft comprising the device according to the invention, when said aircraft is positioned on the ground and in the take-off configuration.

The invention therefore consists in withdrawing part of a stream of cold air at a temperature of from −1° C. to +5° C.—which air is cold and dry, that is to say of humidity lower than the humidity of the ambient cabin air of the aircraft, heating the part of the stream of cold air so as to form a stream of hot and dry air at a temperature of from +10° C. to +60° C., and directing the stream of hot air directly to the crown of the aircraft.

In a method according to the invention, the stream of hot air is directed into the crown without previously being mixed with air—especially with hot air withdrawn from the region of the engines and optionally relaxed to atmospheric pressure—or with recirculated air, which would not have been dried in the air conditioning device.

In a method according to the invention, the stream of hot air introduced into the crown of the aircraft is especially adapted to be able to capture the moisture in the air occupying the crown by a natural process of balancing the partial pressures when the hot and dry air is mixed with the moist air in the crown. The water vapor content of the air in the crown falls as dry air is supplied. Furthermore, the dew point of the air mixture is lowered in the crown, which reduces—or even completely prevents—any condensation phenomenon which would be likely to occur on contact with a cold wall of the aircraft.

The stream of hot and dry air is introduced into the crown directly opposite at least one inner face portion of the fuselage so as to prevent the hot and moist cabin air from condensing on contact with each inner face portion of the fuselage of the crown of said aircraft.

In an anti-condensation method according to the invention:
part of a stream of cold air produced in a device for cooling the cabin air of the aircraft is withdrawn; and then
the part of the stream of cold air is heated so as to form a stream of air, called hot air, at a temperature of from +10° to +60° C.—especially of approximately +35° C.—without mixing the part of the stream of cold air with the air of the aircraft; and then
the stream of hot air is introduced into the crown of the aircraft so as to form a dynamic layer of hot and dry air in contact with the inner face of the wall of the fuselage.

The inventors have observed that the introduction of a stream of hot and dry air into the crown of an aircraft—especially of an aircraft in the in flight state—advantageously allows said crown to be dried. The crown is a space with little ventilation, in which the air is rarely replaced. Furthermore, the temperature in the crown—especially under flight conditions—is lower than the temperature in the space, called the peripheral space, which extends between the inner wall of the fuselage and the side walls of the cabin and opposite those walls. The crown is therefore more favorable to the formation of liquid water by condensation of water vapor from the cabin air loaded with moisture—from the passengers' breathing—and passing by diffusion through the upper wall of the cabin.

It is not impossible that the stream of hot and dry air introduced into the crown, while avoiding the formation—by condensation—of liquid water on the cold inner wall of the fuselage, will also pass by diffusion into the peripheral space extending beyond the crown opposite the inner wall of the fuselage. The stream of hot and dry air introduced into the peripheral space is liable also to contribute to the drying of the peripheral space and to counter the formation of condensation water on the cold inner walls of the fuselage of the aircraft.

It is to be noted that, in an air conditioning device known to the person skilled in the art, the air produced by the air conditioning device at a temperature adapted to allow its introduction into the passenger cabin is obtained by mixing air from the cooling device with recirculated air from the cabin, which is therefore moist air.

Advantageously, in a method according to the invention, part of the stream of cold air is withdrawn upstream of a mixing element (called the mixing chamber or mixing unit) and before the part of the stream of cold air is mixed with hot and moist air—especially with hot air of relative humidity greater than the relative humidity of the air of the part of the stream of cold air, the part of the stream of cold air is heated without being mixed with hot air from the aircraft, and the heated cold air is directed to the crown of the aircraft, and the heated and dry air is delivered into the crown in contact with the inner—especially cold—face of the wall of the fuselage of the aircraft.

By directing part of the stream of cold and then heated air in such a manner that the hot and dry air so obtained circulates in contact with the inner face of the wall of the fuselage, there is formed in contact with the inner face of the wall of the fuselage a layer of air which is drier than the cabin air and which does not form liquid condensation water on the cold inner face of the wall of the fuselage and prevents such formation. In such an anti-condensation method, it is therefore not necessary to use a specific element for capturing and eliminating the liquid water coming from the condensation of the water vapor.

Such an anti-condensation method according to the invention makes it possible on the one hand to avoid contact between the moist cabin air and said cold inner face of the wall of the fuselage, and on the other hand to prevent the condensation of liquid water on contact with the cold inner face of the wall of the fuselage.

In such an anti-condensation method according to the invention, any contact between the moist air coming from the cabin and the cold—especially under flight conditions—inner face of the wall of the fuselage of the crown of the aircraft is limited—or even prevented.

A device for cooling the air of an aircraft is a constituent element of the cabin air conditioning device of an aircraft (called ECS, “environmental control system”). In general, such a conditioning device comprises a plurality of cooling devices—especially two cooling devices—and a plurality of outlet ducts, each cooling device being adapted to produce a stream of cold air in an outlet duct for the stream of cold air extending between each cooling device and the element for mixing the stream of cold air with at least one stream of air separate from the stream of cold air, especially with a stream of recirculated air at a temperature of from +20° C. to +30° C. In such an air conditioning device of an aircraft, the cold air produced by the air cooling device is mixed with hot air from the engines and optionally with recirculated air from the cabin to form the conditioned air which is distributed in the cabin of the aircraft.

In a first variant of an anti-condensation method according to the invention, there is withdrawn—when the aircraft is in the “in flight” state, especially at high altitude—part of the stream of cold air at a temperature of from −1° C. to +5° C. produced by the air cooling device(s) of the aircraft and circulating in an outlet duct extending between the cooling device and a mixing unit of the aircraft. Under these conditions, the air cooled by the cooling device(s) and circulating in the outlet duct has a water vapor content of less than 2 g of water vapor per kilogram of air (2 g/kg)—especially of substantially approximately 1 g/kg—and a liquid water content of substantially zero.

The expression “water vapor content” of a gaseous composition denotes the ratio of the mass of water vapor (in g) to the mass (in kg) of dry air of said gaseous composition, and the expression “liquid water content” of a gaseous composition denotes the ratio of the mass of liquid water (in g) in the form of droplets in suspension in the gaseous composition to the mass (in kg) of dry air of said gaseous composition.

The water vapor content of the stream of cold air is determined by means known per se to the person skilled in the art. In particular, the water vapor content is measured by means of a precision psychrometer comprising a temperature sensor for moist air and a temperature sensor for dry reference air. The temperature difference measured between the temperature sensor for moist air and the temperature sensor for dry reference air—called the psychrometric difference—allows the water vapor content of the moist air to be evaluated. It is also possible to measure the water vapor content of the air by capacitive measurement or by hygrometric measurement of the humidity of the air.

The liquid water content of the air of the stream of cold air corresponds to the quantity of liquid water contained in the air of the stream of cold air for a water vapor partial pressure greater than the saturation pressure at the temperature of the cold air.

In an anti-condensation method according to the invention carried out when the aircraft is in the “in flight” state—especially at high altitude, the outlet duct(s) is/are placed in fluid communication with at least one duct for introduction of said part of the stream of cold air into the peripheral space of the aircraft. Advantageously, said part of the stream of cold air is heated before being introduced into the peripheral space of the aircraft and without mixing said part of the stream of cold air with air from the aircraft, especially with air from the aircraft having a vapor content and/or a liquid water content higher than the vapor content and/or the liquid water content of said part of the stream of cold air.

In an anti-condensation method according to the invention carried out when the aircraft is in the “on the ground” state—that is to say when the aircraft is on the ground in the boarding or disembarking or maintenance phase, or in the take-off phase, or in the landing phase, the stream of cold air is a stream of air having:
a water vapor content of less than 3.5 g/kg, in particular of substantially approximately 3 g/kg; and
a liquid water content of less than 6.5 g/kg, in particular of substantially approximately 6 g/kg.

In an anti-condensation method according to the invention, part of the stream of cold and dry air is withdrawn, and that part of the stream of cold air is heated and that hot and dry air is used for the anti-condensation treatment of the inner face of the wall of the fuselage of the crown of the aircraft. A drying device—especially comprising a material for trapping the moisture in the air, in particular a silica gel—for drying hot and moist air is not used. In an anti-condensation method according to the invention, a device for extracting water vapor from hot and moist air is not used. In particular, a dehumidifying device as described in U.S. Pat. No. 5,386,952 is not used.

Advantageously, in an anti-condensation method according to the invention carried out when the aircraft is in the “on the ground” state, a step is carried out in which liquid water—especially liquid water dispersed in the form of water droplets—is extracted from the part of the stream of cold air, said extraction step being adapted to retain the liquid water of the part of the stream of cold air and to deliver a stream of cold air that is substantially free of liquid water. Such a step of extraction of liquid water is carried out in particular by means of a device adapted to reduce the flow rate of the part of the stream of cold air and allow the water droplets to coalesce and be separated from the stream of cold air.

Advantageously and according to the invention, the step of heating said part of the stream of cold air is carried out using a heating element chosen from the group formed by electric resistance heating elements, elements for heating by heat exchange—especially elements for heating by heat exchange with a source of hot air from the air conditioning device.

Advantageously and according to the invention, in order to carry out said heating step, means for heating said part of the stream of cold air by heat exchange starting from at least one heat source of the aircraft are used.

Advantageously and according to the invention, the heat source(s) of the aircraft is/are chosen from the group formed by primary heat exchangers in the non-pressurized zone, secondary heat exchangers, recirculation lines in the pressurized zone, avionic extraction lines, and hot parts of the liquid loops of the aircraft.

Advantageously, in an anti-condensation method according to the invention, the temperature of the part of the stream of cold air is heated in the heating step to a temperature of from +10° C. to +60° C.—especially of approximately +35° C.

Advantageously, in a method according to the invention, said part of the stream of cold air is heated by means of a heating device adapted to be able to heat and increase the temperature of a stream of cold air and form a stream of hot air having a water vapor content of less than 3 g/kg and a temperature of from +10° C. to +60° C.

The inventors have also found that it is advantageous to form in contact with the inner face of the wall of the fuselage of the crown of an aircraft, in particular of an aircraft in the “in flight” state at high altitude, a layer of hot air—especially having a water vapor content of less than 2 g/kg and a liquid water content of substantially zero.

The stream of hot air is cooled on contact with the cold inner face of the wall of the fuselage and remains substantially dry on contact with said cold wall. It can then be introduced, in admixture with moist air (having a water vapor content of approximately 2.6 g/kg), into the passenger cabin without causing the passengers to feel uncomfortable in response to the use of air that is too dry. The water vapor content in the part of the stream of air that is re-introduced into the passenger cabin is from 1 g/kg to 2.6 g/kg.

In the “on the ground” state, the part of the stream of cold air has a water vapor content of approximately 3 g/kg of air and a liquid water content of from 3 g/kg to 6 g/kg. Heating of the part of the stream of cold air by means of the heating element provides a stream of hot air, of which the temperature is approximately +35° C. and the water vapor content is approximately from 6 to 9 g/kg of air and the liquid water content is substantially zero. The water vapor content of the part of the stream of hot air that is re-introduced into the passenger cabin—in admixture with moist air (having a water vapor content of approximately 12.5 g/kg)—is, under these conditions, from 6 g/kg to 12.5 g/kg.

Advantageously and according to the invention, the flow rate of the part of the stream of hot air in the duct for introduction of said part of the stream of hot air into the crown of the aircraft is adjusted. In particular, in such an anti-condensation method according to the invention, the flow rate of the part of the stream of hot air is adjusted so as to maintain a layer of hot air in contact with the cold inner face of the wall of the fuselage in the crown of the aircraft. Advantageously, the stream of hot air is a stream of hot and dry air.

Advantageously, in an anti-condensation method according to the invention, the temperature of the part of the stream of cold air is heated in the heating step to a temperature adapted to be able to form cabin air of a temperature and moisture content which are adapted to the well-being of the passengers.

The invention relates also to an anti-condensation device for an aircraft, comprising:
a cabin adapted to be able to receive passengers;
a fuselage;
a space, called the crown, which extends between an upper wall of the cabin and a wall of the fuselage;
an air conditioning device adapted to supply, in the cabin of said aircraft, air adapted to maintain the safety and comfort of the passengers;
the air conditioning device comprising at least one device for cooling air at a temperature of from +10° C. to +60° C., said cooling device comprising at least one inlet for air at a temperature of from +10° C. to +60° C. and at least one outlet for a stream of air, called cold air, having a temperature of from −1° C. to +5° C.; wherein the anti-condensation device comprises a device for heating said part of the stream of cold air which extends over at least one duct for introduction of the part of the stream of cold air into the crown, said anti-condensation device being configured to deliver at least part of a stream of hot air into the crown of the aircraft.

Advantageously and according to the invention, the anti-condensation device comprises at least one heating device adapted to be able to heat and increase the temperature of the part of the stream of cold air and form a stream of hot air.

Such an anti-condensation device is configured to deliver a stream of hot air directly into the crown of the aircraft, that is to say without said part of the stream of dry and hot air being mixed with air of relative humidity greater than the relative humidity of the air of said stream of dry and hot air before being introduced into the crown of the aircraft.

The anti-condensation device comprises an element for extraction of liquid water which is adapted to retain the liquid water of the part of the stream of cold air and to deliver the part of the stream of cold air substantially free of liquid water into the duct for introduction of the part of the stream of cold air into the crown. Such an element for extraction of liquid water is known to the person skilled in the art. It can advantageously be a grid device adapted to permit the coalescence of droplets of liquid water of the part of the stream of cold air and the trapping of said coalesced droplets.

Such a device comprising an element for extraction of liquid water is particularly adapted to the operation of the aircraft when it is on the ground. In the “on the ground” state, it in particular allows the liquid water content of the part of the stream of cold air produced by the cooling devices to be reduced. By way of non-limiting example, such an element for extraction of water is adapted to permit the formation of a stream of air having a water vapor content of 3 g/kg and a liquid water content of 3 g/kg from a stream of cold air having a water vapor content of 3 g/kg and a liquid water content of 6 g/kg.

Advantageously and according to the invention, the anti-condensation device comprises at least one device for heating said part of the stream of cold air, which device extends over each duct for introduction of the part of the stream of cold air into the crown and is adapted to be able to heat and increase the temperature of said part of the stream of cold air and form a stream of hot air. In particular, such a heating device is adapted to permit the heating of the stream of cold air and an increase in its temperature without increasing the water vapor content. The stream of hot air therefore has a water vapor content of less than 1 g/kg when the aircraft is in the “in flight” state and a water vapor content of less than 3 g/kg when the aircraft is on the ground.

Advantageously, the heating device is adapted to permit an increase in the temperature of the part of the stream of cold air to a temperature of from +10° C. to +60° C.—especially of approximately +35° C.

Such a heating device is configured so as to extend downstream of the air cooling device and over the duct for introduction of the part of the stream of cold air into the crown. Accordingly, said part of the stream of cold air is heated and then directed to the crown of the aircraft without being mixed with a quantity of air having a higher humidity.

Advantageously and in a variant according to the invention, the device for heating the part of the stream of cold air comprises an electric resistance heating element.

Advantageously, the electric resistance heating element has a consumption of from 1.5 kW to 4.0 kW. In particular, such an electric resistance heating element is adapted to increase the temperature of the stream of dry air from a temperature value of from −1° C. to +5° C. to a temperature of from +30° C. to +40° C.—especially of approximately +35° C.—before it is introduced into the crown of the aircraft.

Advantageously and according to the invention, the device for heating the part of the stream of cold air comprises an element for heating by heat exchange. Advantageously, the element for heating by heat exchange is adapted to permit an exchange of heat between the part of the stream of cold air—which is heated in said element for heating by heat exchange—and recirculated air, in particular cabin air at a temperature of from +20° C. to +30° C.—especially of approximately +24° C.—which is cooled in the element for heating by heat exchange. Advantageously, such an element for heating by heat exchange does not permit the exchange of water vapor between the part of the stream of cold air and the recirculated air.

Advantageously, the device for heating the part of the stream of cold air is formed by an element for heating by heat exchange which is adapted to increase the temperature of the part of the stream of cold air using hot air produced by the cooling device. Accordingly, at least part of the thermal energy dissipated by the air cooling device of the aircraft is recovered and used to permit heating of the part of the stream of cold air. At least part of the thermal energy necessary to heat the stream of cold air is recovered from a heat source which was not utilized prior to the date of the invention.

Advantageously, the anti-condensation device according to the invention comprises, in combination, an electric resistance heating element and an element for heating by heat exchange. In this variant of a device according to the invention, the electric resistance heating element and the element for heating by heat exchange cooperate to form the part of the stream of hot air at a temperature of from +20° C. to +40° C. In this variant of a device according to the invention, the part of the stream of cold air first passes through the element for heating by heat exchange in order to increase its temperature to a value of from +20° C. to +25° C. and then through the electric resistance heating element, which permits the formation of a stream of hot air at a temperature of from +30° C. to +40° C.—especially of approximately +35° C. The electric energy consumption of the electric resistance heating element is then approximately 1 kW.

Advantageously and according to the invention, each duct for introduction of the part of the stream of cold air into the crown comprises an element for regulating the flow rate of the part of the stream of cold air in each introduction duct. Such an element for regulating the flow rate of the part of the stream of cold air positioned on each introduction duct is adapted especially, but not exclusively, to allow the flow rate of the part of the stream of cold air to be adjusted during a transition phase between an “in flight” state and an “on the ground” state of the aircraft.

Advantageously, the flow rate of the part of the stream of cold and dry air is adapted so as to adapt the flow rate of the stream of cold air and the flow rate of the stream of hot air as a function of the humidity of the air in the crown. Accordingly, the consumption of cold air is optimized as a function of the humidity of the air in the crown.

Advantageously and according to the invention, the element for regulating the flow rate of the part of the stream of cold air in each introduction duct into the crown is an automated element.

Advantageously and according to the invention, the duct for introduction of the part of the stream of cold air comprises a portion, called the terminal portion, which extends into the crown of the aircraft and is adapted to deliver the part of the stream of cold air into the crown of the aircraft opposite and close to the inner face of the wall of the fuselage.

Advantageously, the stream of cold air has in each introduction duct a flow rate value of from 20 g/s to 100 g/s.

Advantageously and according to the invention, the terminal portion of each duct for introduction of the stream of hot air into the crown is formed by an open element for distributing the stream of hot air opposite and close to the inner face of the wall of the fuselage of the aircraft. Such an open distribution element, called a piccolo, can be formed by a pipe having orifices which are spaced in the longitudinal direction of said pipe and open opposite the inner face of the wall of the fuselage and are adapted to allow the stream of hot air to be distributed in the crown in the direction of said inner face of the wall of the fuselage.

In a variant, the terminal portion is formed by an element for distribution of the stream of hot air which is formed of a material that is permeable—especially porous—to the stream of hot air.

Advantageously, the anti-condensation device comprises at least one thermometer for measuring the temperature of the part of the stream of hot air in each duct for introduction of the part of the stream of hot air into the crown of the aircraft.

Advantageously, the anti-condensation device comprises at least one element for measuring the flow rate of the part of the stream of hot air in each duct for introduction of the part of the stream of hot air into the crown of the aircraft.

Advantageously, the anti-condensation device comprises at least one control unit adapted to:
control each element for regulating the flow rate of the part of the stream of cold air and permit adjustment of the flow rate of the part of the stream of cold air; and to
control the heating device and permit adjustment of the temperature of the part of the stream of cold air.

The invention relates also to such an anti-condensation method for preventing condensation of the cabin air of an aircraft, in which an anti-condensation device according to the invention is used.

The invention relates also to the use of such an anti-condensation device according to the invention for eliminating moisture from the crown of an aircraft and dehumidifying it.

The invention relates also to an aircraft equipped with an anti-condensation device according to the invention.

The invention relates also to an anti-condensation method for an aircraft, to an anti-condensation device and to the use of such an anti-condensation device, characterized in combination by all or some of the features mentioned above or below.

Other objects, features and advantages of the invention will become apparent upon reading the following description, which refers to the accompanying figures showing preferred embodiments of the invention, given solely by way of non-limiting examples, and in which:

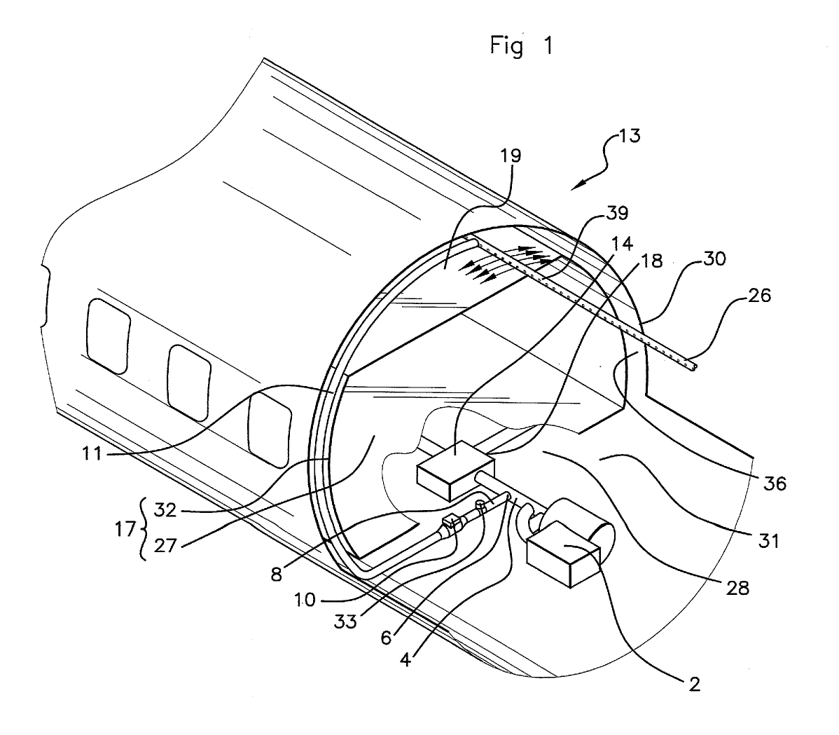

FIG. 1 is a general cutaway view of a fuselage of an aircraft comprising an anti-condensation device according to the invention,

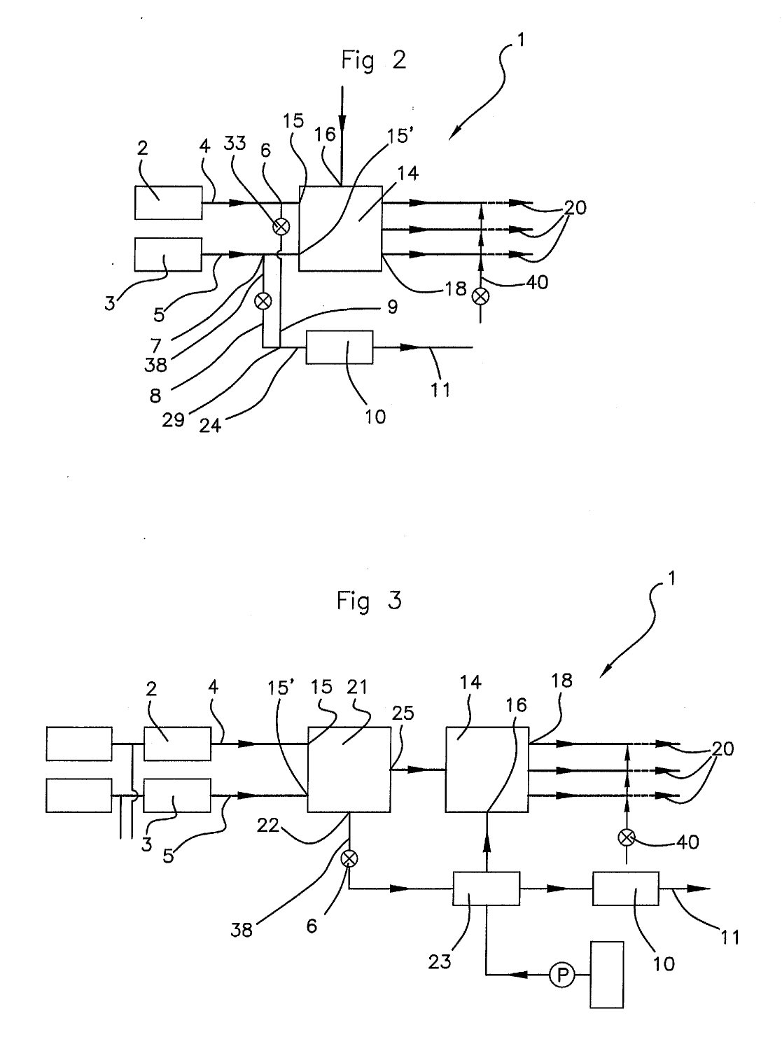

FIG. 2 is a schematic view of a first variant of a device according to the invention,

FIG. 3 is a schematic view of a second variant of a device according to the invention.

For the purpose of clarity, the dimensions of the anti-condensation device 1 shown in FIG. 1 are not representative of the dimensions of such a device fitted in an aircraft 13. An aircraft 13 equipped with an anti-condensation device 1 according to the invention is shown in FIG. 1 and comprises a fuselage 30 delimiting an inner space 31 containing the air of the aircraft 13. Such an aircraft 13 further comprises a cabin, called the passenger cabin 17, delimited by a separating partition 32 between a space, called the cabin space 27, adapted to be able to receive the passengers, and a crown 19 extending between an upper part of said partition 32 and an inner face 36 of the fuselage 30.

An anti-condensation device 1 shown schematically in FIG. 1 as positioned in an aircraft 13 comprises a cooling device 2 (environmental control system, ECS) which extends in a lower ceiling space 28 of the aircraft 13. Such an anti-condensation device 1 according to the invention comprises an outlet duct 4 for a stream of dry and cold air produced by the air cooling device 2, said outlet duct 4 for the stream of dry and cold air being in fluid communication with an element 14 for mixing said stream of dry and cold air with a stream of air, called recirculated air, from the cabin 17.

An anti-condensation device 1 of an aircraft according to the invention comprises an element 6 for withdrawing part of the stream of dry and cold air flowing in the outlet duct 4 for the stream of dry and cold air, which element 6 is adapted to allow said part of the stream of dry and cold air to be withdrawn and to orient said part of the stream of dry and cold air into a duct 8, 9 for introduction of said part of the stream of dry and cold air into the crown 19 of the aircraft 13 via the directing system 11. The duct 8, 9 for introduction of said part of the stream of dry and cold air optionally has an element 33 for regulating the flow rate of said part of the stream. Such a regulating element 33 is adapted in particular to allow the flow rate of said part of the stream of dry and cold air to be controlled and to adapt the flow rate of the dry and cold air to the use conditions (flight/parking on the ground/take off/landing) of the aircraft 13.

It is to be noted that, in order to simplify FIG. 1, the anti-condensation device 1 has a single air cooling device 2, a single outlet duct 4, a single withdrawal element 6 and a single introduction duct 8, 9. In reality, it is possible for such an anti-condensation device 1 of the aircraft 13 to have a plurality of cooling devices 2, 3—especially two cooling devices 2, 3 distributed substantially symmetrically on either side of the plane of axial symmetry of the aircraft 13. The anti-condensation device 1 then comprises, downstream of each air cooling device 2, an outlet duct 4, 5, a withdrawal element 6, 7 and a duct 8, 9 for introduction of the part of the stream of dry and cold air into the crown. The two withdrawal elements 6, 7 then meet at the T-shaped junction 29 and open into the system 11 for directing the part of the stream of dry and cold air into the crown 19 of the aircraft 13.

An anti-condensation device 1 for an aircraft 13 shown in FIG. 1 comprises a heating device 10 which extends upstream of the withdrawal element 6. In the variant shown in FIG. 1, the heating device 10 extends downstream of an element 33 for regulating the flow rate of the part of the stream of dry and cold air circulating in the introduction duct 8, 9. Such a heating device 10 is adapted to permit heating of the air of the part of the stream of dry and cold air and to increase its temperature to a value of from +10° C. to +60° C. The part of the stream of dry and cold air then flows into a system 11 for directing the part of the stream of dry and cold air into the crown 19 of the aircraft 13. Such a directing system 11 is formed of a single section or of a plurality of sections forming a gas-tight duct. The terminal portion 39 of the directing system 11 is formed of a piccolo 26 adapted to allow the part of the stream of dry and cold air to be distributed in the crown 19 of the aircraft 13.

An anti-condensation device 1 of an aircraft 13 according to the invention shown schematically in FIG. 2 comprises two air cooling devices 2, 3 which are each adapted to generate, in an outlet duct 4, 5, a stream of dry air of low temperature, in particular of from −3° C. to +3° C., preferably of approximately −0.1° C. in the “in flight” state and approximately −2.5° C. in the “on the ground” state. The stream of air produced by each of the air cooling devices 2, 3 used in the “in flight” state (low external temperature) is dry and cold air.

The anti-condensation device 1 of an aircraft 13 shown in FIG. 2 also comprises two air withdrawal elements 6, 7 which are configured so as to allow at least part of the air produced by each of the cooling devices 2, 3 to be withdrawn and to place each of the cooling devices 2, 3 in fluid communication with a duct 8, 9 for introduction of said part of the stream of dry and cold air into the crown 19 of the aircraft 13 via the directing system 11. In the device shown schematically in FIG. 2, each duct 8, 9 for introduction of said part of the stream of dry and cold air into the crown 19 has an element 33, 34 for regulating the flow rate of the part of the stream of dry and cold air. Each introduction duct 8, 9 is configured to meet at a T-shaped junction 29 and to form a common section 24 for distribution of the part of the stream of dry and cold air in the directing system 11. The common distribution section 24 comprises a device 10 for heating the part of the stream of dry and cold air produced by each of the air cooling devices 2, 3. In a variant (not shown), it is possible for the anti-condensation device 1 of an aircraft 13 to comprise a plurality of heating devices 10—especially two heating devices 10—each of which extends on and in contact with an introduction duct 8, 9.

In an anti-condensation device 1 according to the invention, the heating device 10 extends over each introduction duct 8, 9 close to the withdrawal elements 6, 7 and downstream thereof

The anti-condensation device 1 of an aircraft 13 shown in FIG. 2 further comprises a mixing unit 14 comprising at least one inlet 15, 15′ for the stream of air produced by the cooling device(s) 2, 3 and an air inlet, called the recirculated air inlet 16, which is adapted to permit recirculation of the moist and tempered air withdrawn from the cabin 17 of the aircraft 13. The mixing unit 14 also comprises at least one outlet 18 for air, called outlet air, obtained by mixing the stream of dry and cold air produced by the cooling device(s) 2, 3 and recirculated air. The air outlet 18 of the mixing unit 14 is in fluid communication with a system 20 for distribution of conditioned air in the cabin 17 of the aircraft 13, said system 20 being adapted to allow the outlet air of the element 14 to be mixed with hot and moist air, called trim air, withdrawn from the region of the compressors of the engines of the aircraft 13 and supplied by means of a feeder 40.

In a first variant according to the invention shown in FIG. 3, an anti-condensation device 1 of an aircraft 13 comprises, extending upstream of the mixing unit 14, at least one pre-mixing unit 21 comprising at least two inlets 15, 15′ for the stream of air produced by the cooling device(s) 2, 3 into the pre-mixing unit 21, an outlet 25 for cabin air from the pre-mixing unit 21 in fluid communication with the mixing unit 14, and an outlet 22 for dehumidified air from said pre-mixing unit 21 to a heat exchanger 23.

In a variant (not shown), a device according to the invention further comprises, extending between the outlet 22 for dehumidified air from the pre-mixing unit 21 and the heat exchanger 23, an element 38 for extraction of liquid water from the part of the stream of air produced by the cooling device(s) 2, 3. Such an element 38 is adapted to extract liquid water from the part of the stream of air produced by the cooling device(s) 2, 3 and to dry the crown 19.

The outlet 22 for dehumidified air from the pre-mixing unit 21 is in fluid communication with the heat exchanger 23 being adapted to permit heat exchange between the part of the stream of dry and cold air at the outlet of the pre-mixing unit 21 and the tempered and moist recirculated air, prior to the entry of the recirculated air through the inlet 16 for recirculated air into the mixing unit 14. In such a variant of a device according to the invention, the stream of dehumidified air at the outlet 22 of the pre-mixing unit 21 does not come back into contact with the recirculated air. An anti-condensation device 1 according to this first variant of the invention also comprises, upstream of the heat exchanger 23, a heating device 10 which extends upstream over the directing system 11 for the part of the stream of dry and cold air.

### EXAMPLE 1

### Anti-Condensation Device with Electric Heating and In “In Flight” Operating Mode

In an air treatment device of the prior art—for example an in flight Airbus A320 device—the two air cooling devices each deliver to the mixing unit a stream of air at a temperature of approximately +3° C., the flow rate of which is approximately 500 g/s. This cold air has a water vapor content of approximately 1 g/kg and a liquid water content of substantially zero.

In an anti-condensation device according to the invention, the flow rate of the stream of dry and cold air obtained from each air cooling device at the inlet of the mixing unit is 465 g/s. In order to compensate for the loss of flow rate of dry and cold air (from 500 g/s to 465 g/s), the cooling devices produce a stream of dry and cold air at a temperature of −0.1° C. It is to be noted that, according to the specifications of the air cooling devices of an Airbus A320, their operation is optimal for the production of air at a temperature of −2.5° C. The withdrawal of this part of the stream of dry and cold air therefore has no impact on the cabin temperature.

The stream of dry and cold air is mixed in the mixing unit with a stream of recirculated air at a temperature of +24° C., having a water vapor content of approximately 2.6 g/kg, a liquid water content of substantially zero and a flow rate of approximately 600 g/s. At the outlet of the mixing unit, and after being mixed with the trim air, the stream of air for the cabin is at a temperature of +24° C., the water vapor content is 2.6 g/kg and the liquid water content is substantially zero. The air which is to be introduced into the “passenger” cabin is obtained by mixing the stream of air leaving the mixing unit with the trim air. The air intended for the cabin has a temperature of +24° C., a water vapor content of from 1 to 2.6 g/kg and a liquid water content of substantially zero.

In an anti-condensation device according to the invention operating in the “in flight” state, the flow rate of the part of the stream of dry and cold air is 35 g/s in each introduction duct and 70 g/s in the common section. The heating device is an electric resistance device, the power of which is 2.5 kW. It allows the part of the stream of dry and cold air to be heated and its temperature increased from an initial value of −0.1° C. to a final value of +35° C. The stream of hot and dry air delivered at the outlet of the electric resistance device and into the peripheral space of the aircraft has a water vapor content of 1 g/kg and a liquid water content of substantially zero. Mixing this stream of hot and dry air with the cabin air in the peripheral space leads to the formation of a stream of air of which the water vapor content is from 1 to 2.6 g/kg.

The crown air introduced into the peripheral space of the aircraft is dried to a value of 1 g/kg for an electric power of 2.5 kW.

### EXAMPLE 2

### Anti-Condensation Device with Electric Heating and in “on the Ground” Operating Mode

In an air treatment device of the prior art, each air cooling device delivers to the mixing unit a stream of dry and cold air at a temperature of approximately +3° C. and the flow rate of which is approximately 500 g/s. The air of this stream of dry and cold air has a water vapor content of approximately 3 g/kg and a liquid water content of approximately 6 g/kg.

In an anti-condensation device according to the invention, the flow rate of the stream of dry and cold air from each cooling device at the inlet of the mixing unit is 465 g/s. In order to compensate for the loss of flow rate of dry and cold air (from 500 g/s to 465 g/s), the cooling devices produce a stream of dry and cold air at a temperature of −2.3° C.

The stream of dry and cold air is mixed in the mixing unit with a stream of recirculated air at a temperature of +24° C., having a water vapor content of approximately 12.5 g/kg, a liquid water content of substantially zero and a flow rate of approximately 770 g/s. At the outlet of the mixing unit, and after being mixed with the trim air, the stream of air to be introduced into the passenger cabin is at a temperature of +24.7° C., the water vapor content is 12.5 g/kg and the liquid water content is substantially zero.

In a device according to the invention, the flow rate of the part of the stream of dry and cold air is 40 g/s in each introduction duct and 80 g/s in the common section.

The heating device is an electric resistance device, the power of which is 4.5 W. It allows the part of the stream of dry and cold air to be heated and its temperature increased from an initial value of −2.3° C. to a final value of +35° C. The stream of hot and dry air delivered at the outlet of the electric resistance device into the peripheral space of the aircraft has a water vapor content of from 9 to 12.5 g/kg and a liquid water content of substantially zero.

The crown air introduced into the peripheral space of the aircraft is dried to a value of from 9 to 12.5 g/kg for an electric power of 4.5 kW.

In this variant of the invention (electric heating), the crown air introduced into the peripheral space of the aircraft is dried to a value of less than 3% humidity in the “in flight” state and less than 26% humidity in the “on the ground” state.

### EXAMPLE 3

### Anti-Condensation Device with Electric Heating and Heating by Heat Exchanger in “in Flight” Operating Mode

In a variant of an anti-condensation device according to the invention, each cooling device produces a stream of dry and cold air directed to a pre-mixing unit which is in fluid communication with the mixing unit.

The streams of dry and cold air emitted by each of the cooling devices have a temperature of −0.1° C., a water vapor content of approximately 1 g/kg and a liquid water content of substantially zero and are mixed in the pre-mixing unit. The part of the stream of dry and cold air withdrawn upstream of the pre-mixing unit is directed towards a heat exchanger with a flow rate of substantially 70 g/s in order to be heated there. The heat exchange is carried out with a stream of recirculated air (cabin air) at a temperature of +24° C., having a water vapor content of approximately 2.6 g/kg, a liquid water content of substantially zero and a flow rate of approximately 600 g/s. The recirculated air is cooled to a temperature of +21.4° C. and is introduced into the mixing unit of the device without alteration of the water vapor content. The part of the stream of dry and cold air, at the outlet of the heat exchanger, is heated to a temperature of +22.3° C. and has a water vapor content of approximately 1 g/kg and a liquid water content of substantially zero.

This part of the stream of hot and dry air leaving the heat exchanger is directed towards an electric heating device in which it is heated to a temperature of +35° C. The electric power required for this heating is 1 kW.

In this variant of a device in the “in flight configuration” according to the invention, the crown air introduced into the peripheral space of the aircraft is dried to a value of 1 g/kg for an electric power of 1 kW.

### EXAMPLE 4

### Anti-Condensation Device with Electric Heating and Heating by Heat Exchanger in “on the Ground” Operating Mode

In a variant of an anti-condensation device according to the invention adapted for operation “on the ground”, each cooling device emits a stream of dry and cold air having a temperature of −2.3° C., a water vapor content of approximately 3 g/kg and a liquid water content of approximately 6 g/kg and a flow rate of approximately 460 g/s into the pre-mixing unit.

The part of the stream of dry and cold air withdrawn from the pre-mixing unit is directed with a flow rate of substantially approximately 80 g/s to a heat exchanger, passing through a water extractor in which the liquid water content of said part of the stream of dry and cold air is adjusted from 6 g/kg to 3 g/kg. The part of the stream of dry and cold air withdrawn is brought into contact with the heat exchanger in order to be heated therein. The heat exchange is carried out with a stream of recirculated air (cabin air) at a temperature of +24° C., having a water vapor content of approximately 12.5 g/kg, a liquid water content of substantially zero and a flow rate of approximately 770 g/s. The temperature of the recirculated air at the outlet of the heat exchanger is +20.6° C. for a water vapor content of approximately 12.5 g/kg, a liquid water content of substantially zero.

The part of the stream of dry and cold air at the outlet of the heat exchanger and at the inlet of the electric heating device has a temperature of +22.2° C., a water vapor content of approximately 6 g/kg and a liquid water content of substantially zero. The energy required to heat and increase the temperature of the part of the stream of dry and cold air to a value of +35° C. is 1.3 kW.

In this variant of a device in the “on the ground configuration” according to the invention, the crown air introduced into the peripheral space of the aircraft is dried from 12.5 g/kg to 6 g/kg for an electric power of 1.3 kW.

1. An anti-condensation method for an aircraft (13), said aircraft (13) comprising:
a cabin (17) adapted to be able to receive passengers;
a fuselage (30);
a space, called the crown (19), which extends between an upper wall of the cabin (17) and a wall of the fuselage (30);
an air conditioning device adapted to supply the cabin (17) with air adapted to maintain the safety and comfort of the passengers;
the air conditioning device comprising at least one device (2, 3) for cooling air at a temperature of from +10° C. to +60° C., said cooling device (2, 3) comprising at least one air inlet and at least one outlet for a stream of air, called cold air, having a temperature of from −1° C. to +5° C.;
wherein:
at least part of the stream of cold air is withdrawn;
and then
a step is carried out in which said part of the stream of cold air is heated so as to form a stream of air, called hot air, at a temperature of from +10° to +60° C.;
and then
the stream of hot air obtained is introduced into the crown (19) of the aircraft (13).

2. The method as claimed in claim 1, wherein said heating step is carried out using a heating element chosen from the group formed by electric resistance heating elements, elements for heating by heat exchange.

3. The method as claimed in claim 1, wherein, in order to carry out said heating step, there are used means for heating said part of the stream of cold air by heat exchange using at least one heat source of the aircraft (13).

4. The method as claimed in claim 3, wherein the heat source(s) of the aircraft (13) is/are chosen from the group formed by primary heat exchangers in the non-pressurized zone, secondary heat exchangers, recirculation lines in the pressurized zone, avionic extraction lines, and hot parts of the liquid loops of the aircraft (13).

5. An anti-condensation device (1) for an aircraft (13), comprising:
a cabin (17) adapted to be able to receive passengers;
a fuselage (30);
a space, called the crown (19), which extends between an upper wall of the cabin (17) and a wall of the fuselage (30);
an air conditioning device adapted to supply the cabin (17) of said aircraft with air adapted to maintain the safety and comfort of the passengers;
the conditioning device comprising at least one device (2, 3) for cooling air at a temperature of from +10° C. to +60° C., said cooling device comprising at least one inlet for air at a temperature of from +10° C. to +60° C. and at least one outlet for a stream of air, called cold air, having a temperature of from −1° C. to +5° C.;
wherein the anti-condensation device (1) comprises a device (10) for heating said part of the stream of cold air, said heating device (10) extending over at least one duct (8, 9) for introduction of the part of the stream of cold air into the crown (19), said anti-condensation device (1) being configured to deliver at least part of a stream of hot air into the crown (19) of the aircraft (13).

6. The device as claimed in claim 5, wherein it comprises a water extraction element (38) adapted to retain the liquid water of the part of the stream of cold air and to deliver into the crown (19) part of the stream of cold air substantially free of liquid water.

7. The device as claimed in claim 5, wherein the device (10) for heating the part of the stream of cold air comprises an electric resistance heating element (35).

8. The device as claimed in claim 5, wherein the device (10) for heating the part of the stream of cold air comprises an element (37) for heating the part of the stream of cold air by heat exchange.

9. The device as claimed in claim 8, wherein the electric resistance heating element (35) has a consumption of from 1.5 kW to 4.0 kW.

10. The device as claimed in claim 5, wherein it comprises an element (33, 34) for regulating the flow rate of the part of the stream of cold air in each introduction duct (8, 9).

11. The device as claimed in claim 5, wherein each duct for transfer of the stream of hot air into the crown (19) comprises an element for regulating the flow rate of the part of the stream of hot air in each transfer duct.

12. The device as claimed in claim 10, wherein the element (33, 34) for regulating the flow rate of the stream of cold air is a valve (33, 34).

13. A method of reducing condensation on an aircraft comprising steps of providing and activating an anti-condensation device as claimed in claim 5 on board the aircraft (13).

14. An aircraft (13) equipped with an anti-condensation device as claimed in claim 5.

15. The method as claimed in claim 2, wherein, in order to carry out said heating step, there are used means for heating said part of the stream of cold air by heat exchange using at least one heat source of the aircraft (13).

16. The device as claimed in claim 6, wherein the device (10) for heating the part of the stream of cold air comprises an electric resistance heating element (35).

17. The device as claimed in claim 6, wherein the device (10) for heating the part of the stream of cold air comprises an element (37) for heating the part of the stream of cold air by heat exchange.

18. The device as claimed in claim 7, wherein the device (10) for heating the part of the stream of cold air comprises an element (37) for heating the part of the stream of cold air by heat exchange.

19. The device as claimed in claim 6, wherein it comprises an element (33, 34) for regulating the flow rate of the part of the stream of cold air in each introduction duct (8, 9).

20. The device as claimed in claim 7, wherein it comprises an element (33, 34) for regulating the flow rate of the part of the stream of cold air in each introduction duct (8, 9).
